(19) United States
(12) Patent Application Publication
(10) Pub. No.: US 2013/0163033 A1
(43) Pub. Date: Jun. 27, 2013

(54) Order of Print Queue

(71) Applicants: Mark Sandler, Rehovot (IL); Gidi Amir, Nes Ziona (IL); Shai Lior, Rehovot (IL); Noam Shaham, Mazkeret Batia (IL); Peter Nedelin, Ashdod (IL)

(72) Inventors: Mark Sandler, Rehovot (IL); Gidi Amir, Nes Ziona (IL); Shai Lior, Rehovot (IL); Noam Shaham, Mazkeret Batia (IL); Peter Nedelin, Ashdod (IL)

(21) Appl. No.: 13/334,553

(22) Filed: Dec. 22, 2011

(51) Int. Cl. G06K 15/02

(52) U.S. Cl. 358/1.15

(57) ABSTRACT

An image forming system and a method to order at least two print jobs in a print queue of an image forming system are provided herein. The method ranks the at least two print jobs set in the print queue based on at least one print characteristic. The method resets an order of the at least two print jobs in the print queue based on the rank, such that a first page of a second print job is ordered prior to a last page of a first print job.

### BACKGROUND

Image forming systems, such as liquid electrophotography (LEP) systems, form images on media. Liquid electrophotography systems include a fluid applicator unit, a photoconductive member, an image transfer member, and an impression member. The image formed on the photoconductive member is transferred to the image transfer member, and then is provided to the media. The impression member may be used to transfer the image from the image transfer member to the media.

### BRIEF DESCRIPTION OF THE DRAWINGS

Non-limiting examples of the present disclosure are described in the following description, read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figures:

FIG. 1 illustrates a schematic view of an image forming system according to an example;

FIG. 2 illustrates a block diagram of the image forming system according to an example;

FIG. 3 illustrates a block diagram of a portion of the image forming system according to an example;

FIG. 4 illustrates a reset print queue according to an example;

FIG. 5 illustrates a flow chart of a method to order at least two print jobs in a print queue according to an example; and

FIG. 6 illustrates a flow chart of a method to order at least two print jobs in a print queue according to a further example.

### DETAILED DESCRIPTION

In the following detailed description, reference is made to the accompanying drawings which form a part hereof, and in which is depicted by way of illustration specific examples in which the present disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims.

An image forming system includes an image transfer member, such as an intermediate transfer member (ITM), and an impression member, such as a roller device. The image transfer member receives ink from a photoconductive member (PIP). The image transfer member has an image transfer media, such as a replaceable blanket attached to the outer surface of the image transfer member to receive the fluid image and transfer the fluid image to a media. The PIP and image transfer media are replaced on a regular basis during normal use. The frequency of the replacement of the PIP and blanket depends on the print characteristics of the print jobs printed on the PIP and blanket. For example, when a portion of the blanket is printed on and/or not printed on repeatedly, the PIP and/or blanket memory may cause change of gray level in that portion for subsequent print jobs since a portion(s) of the blanket that is/are over utilized become worn.

In examples, an image forming system and a method to order at least two print jobs in a print queue of an image forming system are provided herein. The method ranks the at least two print jobs set in the print queue based on at least one print characteristic. The method resets an order of the at least two print jobs in the print queue based on the rank. The reset order may be used to reduce memory on an image transfer media and increase the longevity of the image transfer media.

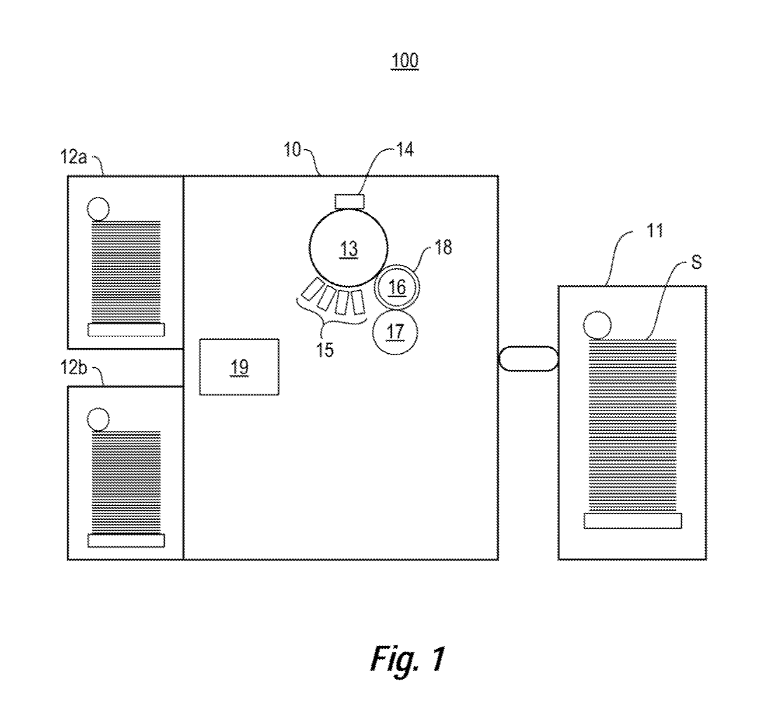

FIG. 1 illustrates a schematic view of an image forming system, such as a liquid electrophotography system (LEP), according to an example. The LEP 100 includes an image forming unit 10 that receives a media S from an input unit 11 and outputs the media S to output units 12a and 12b. The image forming unit 10 includes a photoconductive member 13 on which images can be formed. The photoconductive member 13 may be charged with a suitable charger (not illustrated), such as a charge roller. Portions of the outer surface of the photoconductive member 13 that correspond to the features of the image can be selectively discharged by a laser writing unit 14 to form an electrostatic and/or latent image thereon.

Referring to FIG. 1, the LEP 100 also includes an applicator unit 15 to apply ink, such as a liquid toner, for example, ElectroInk, trademarked by Hewlett-Packard Company, to the electrostatic and/or latent image on the photoconductive member 13. The ink is applied to the photoconductive member 13 to form a fluid image to be transferred to an image transfer member 16, such as an intermediate transfer member (ITM) and an impression member 17, such as a roller device. The image transfer member 16 has an image transfer media 18, such as a blanket attached thereto that transfers the fluid image to the media S. During the transfer of the fluid image from the image transfer media 18 to the media S, the media S is pinched between the image transfer media 18 and the impression member 17. Once the fluid image has been transferred to the media S, the media S can be transported to one of the output units 12a and 12b, as determined by a distribution mechanism 19. For example, the output units may be output trays to collect at least one sheet each.

The phrase “image forming unit” refers to an apparatus used to form an image. For example, an “image forming unit” may include a printing press and/or a printer.

The phrase “image transfer media” refers to a portion of an image forming unit, such as a blanket, that has an image formed thereon and transfers an image to a media sheet.

The term “media” refers to at least one sheet of material to be printed on, such as paper, film, and/or fabric. The terms “media sheet,” “page,” and/or “sheet” may be used interchangeably to refer to media.

The phrase “print job” refers to at least one page of, for example, images, text, and/or drawings that fit on a portion of a media sheet. The print job may include multiple sheets each having an identical image and/or group of images printed repeatedly and/or a plurality of distinct images that are printed in sequence.

The phrase “print characteristics” refers to at least one of the following characteristics that describe a print job and include characteristics that may cause memory on an image transfer media 18. For example, a media type, a media size, a number of media sheets per print job, an image coverage area, a color hue, a repeated image pattern, and an image position. The media type characteristics may include a determination of the thickness and/or finish, such as matte or glossy, of the media sheets. The image coverage area may determine for example, if the image covers an entire media sheet, such as full coverage, only a portion of the media sheet, such as partial coverage, and/or the media sheet with full coverage that includes multiple ink layers that provide more than full coverage. The image coverage area may further include subcategories depending on the location of the coverage and/or percentage of area covered. The color hue may determine the hue of a portion of the media sheet, such as a dark hue, a light hue, and/or a degree of hue therebetween. The repeated image pattern identifies when multiple media sheets in a print job have the same image in the same location multiple times. The image position identifies when multiple media sheets in a print job have similar images in similar locations and/or when images have voids, i.e., non-printed areas.

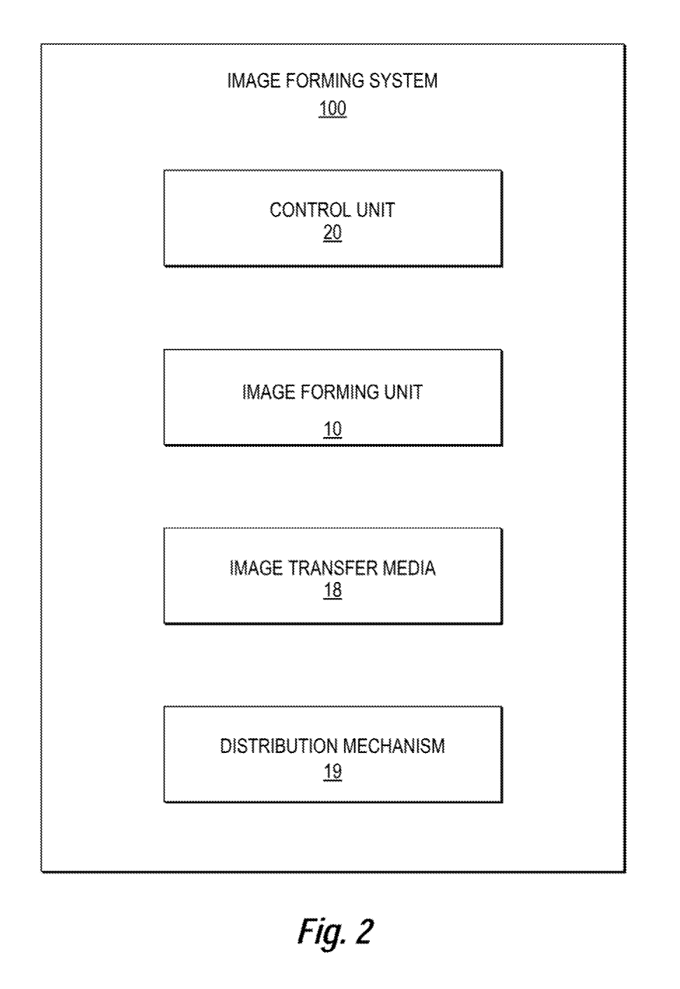

FIG. 2 illustrates a block diagram of the image forming system 100 according to an example. The image forming system includes a control unit 20, an image forming unit 10, an image transfer media 18, and a distribution mechanism 19. The control unit 20 selectively controls an order in which at least two print jobs having at least two images are printed. For example, the control unit 20 controls the print queue such that a first page of a second print job is ordered prior to a last page of a first print job. For example, a print queue may be ordered to alternate printing of pages between the first print job and the second print job to avoid memory on an image transfer media 18.

The image forming unit 10 forms each one of the at least two images. The order that the at least two images are formed is controlled by the control unit 20. The image transfer media 18 receives each one of the at least two images formed on the image forming unit 10, i.e., the photoconductive member 13, and transfers each one of the at least two images to media, such as media S of FIG. 1, to form at least two printed pages. An example of an image transfer media 18 is a blanket that is attached to an image transfer member 16.

The distribution mechanism 19 directs the at least two printed pages from the image forming unit 10 to a plurality of output trays, such that each one of the at least two print jobs correspond to one of the plurality of output trays. Referring back to FIG. 1, the image forming system is illustrated with two output trays 12a and 12b; however, two or more output trays may be included in the system 100. The distribution mechanism 19 and the control unit 20 work together to direct each of the print jobs to an output tray and to keep the print jobs separate. For example, referring back to FIG. 1, a first print job may be directed to a first output unit 12a and a second print job may be directed to a second output unit 12b.

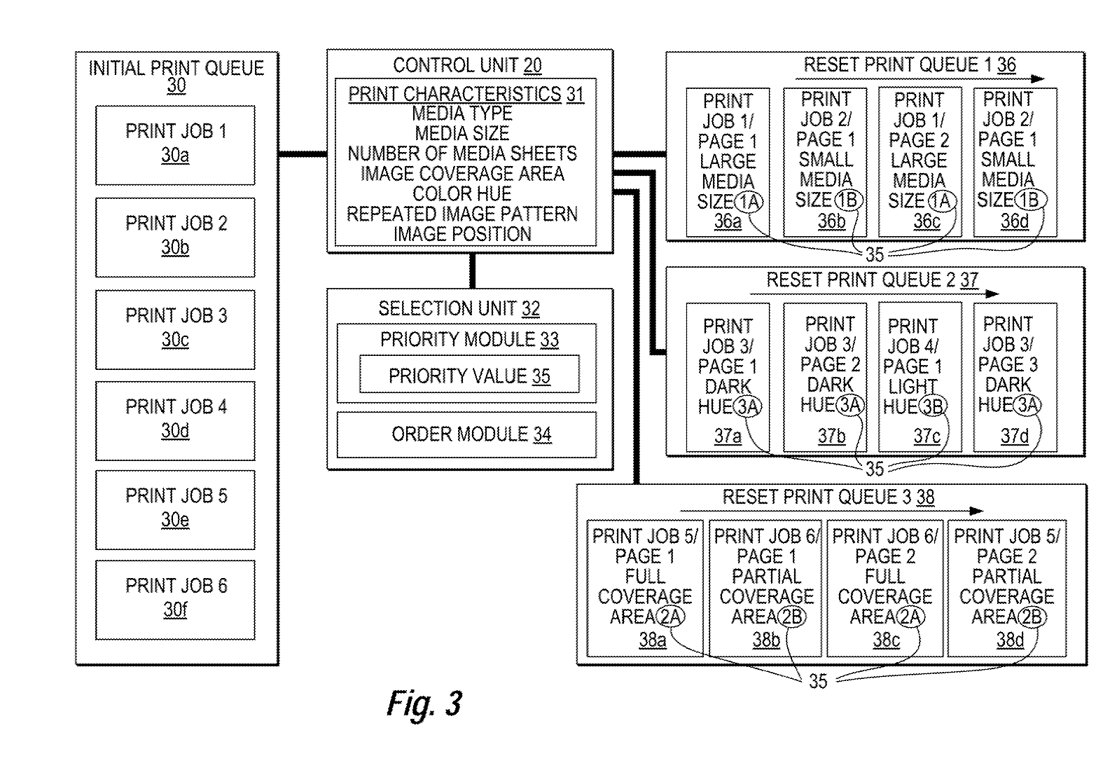

FIG. 3 illustrates a block diagram of a portion of the image forming system 100 according to an example. The image forming system 100 includes an initial print queue 30 that includes at least two print jobs. For example, FIG. 3 includes six print jobs illustrated as print job 1 (30a) through print job 6 (30f). The control unit 20 determines at least one of the print characteristics 31 of the initial print queue 30. The print characteristics 31 of a print job may include at least one of a media type, a media size, a number of media sheets per print job, an image coverage area, a color hue, a repeated image pattern, and an image position. The print jobs in the initial print queue 30 are ordered by the control unit 20 based on at least one of the print characteristics 31. The control unit 20 may use a selection unit 32 to select the order that the print jobs are printed based on at least one print characteristic. For example, the selection unit 32 may include a priority module 33 and an order module 34. The priority module 33 assigns a priority value 35 to each page of the at least two print jobs based on the at least one of the print characteristics 31. The order module 34 ranks one of the at least two print jobs prior to the other of the at least two print jobs based on the priority value 35.

The control unit 20 then orders the at least two print jobs based on at least one of the print characteristics 31. The control unit 20 may determine order the at least two print jobs by, for example, a comparison of the print characteristic and/or other methods may be used to order the at least two print jobs. The control unit 20 also resets the order of the print queue. FIG. 3 illustrates examples of portions of the reset print queues based on the print characteristics 31.

Reset print queue 1 (36) is illustrated with the following print queue order: print job 1/page 1 is ordered first 36a with a large media size, print job 2/page 1 is ordered second 36b with a small media size, print job 1/page 2 is ordered third 36c with a large media size, and print job 2/page 2 is ordered fourth 36d with a small media size. As illustrated the order of the print jobs alternates printing between two print jobs 30a, 30b, such that one page from each print job is printed in an alternating order. The alternating order may be based on the print characteristics 31. In the example reset print queue 1, the large media size 36a is assigned a priority value 35 of 1A and is printed first, and the small media size 36b is assigned a priority value 35 of 1B and printed second. The order is arranged to alternate printing between the large media size pages, i.e., 36a, 36b, and the small media size pages, i.e., 36b, 36d. The number of pages printed from each print job is the same in reset print queue 1 (36) but the order may vary, such that the alternating order does not include the same number of pages from each print job, as illustrated in reset print queue 2 (37) and reset print queue 3 (38).

Reset print queue 2 (37) is illustrated with the following print queue order: print job 3/page 1 is ordered first 37a with a dark hue, print job 3/page 2 is ordered second 37b with a dark hue, print job 4/page 1 is ordered third 37c with a light hue, and print job 3/page 3 is ordered fourth 37d with a dark hue. As illustrated the order of the print jobs alternates printing between two print jobs 30c, 30d, such that the pages from each print job are printed in an alternating order based on the priority value 35. For example, the dark hue has a priority value 35 of 3A and the light hue has a priority value 35 of 3B. Instead of alternating between one page of print job 3 and one page of print job 4, the control unit 20 uses the print characteristics 31 to determine the alternating order. In the example reset print queue 2, the order is arranged to print two pages 37a, 37b from print job 3 prior to the first page 37c of print job 4 and then switch back to the third page 37d of print job 3 after the first page of print job 4. Other factors, such as number of pages in each print job, may be used to determine the order and the alternating order.

Reset print queue 3 (38) is illustrated with the following print queue order: print job 5/page 1 is ordered first 38a with a full coverage area, print job 6/page 1 is ordered second 38b with a partial coverage area, print job 6/page 2 is ordered third 38c with a full coverage area, and print job 5/page 2 is ordered fourth 38d with a partial coverage area. As illustrated the order of the print jobs alternates printing between two print jobs 30e, 30f, such that the pages from each print job are printed in an alternating order based on the priority value 35. In reset print queue 3 (38), the order is set to alternate printing between the full coverage area 30a, 38c pages and the partial coverage area pages 38b, 38d. The priority value 35 for the full coverage area is 2A and the priority value for the partial coverage area is 2B.

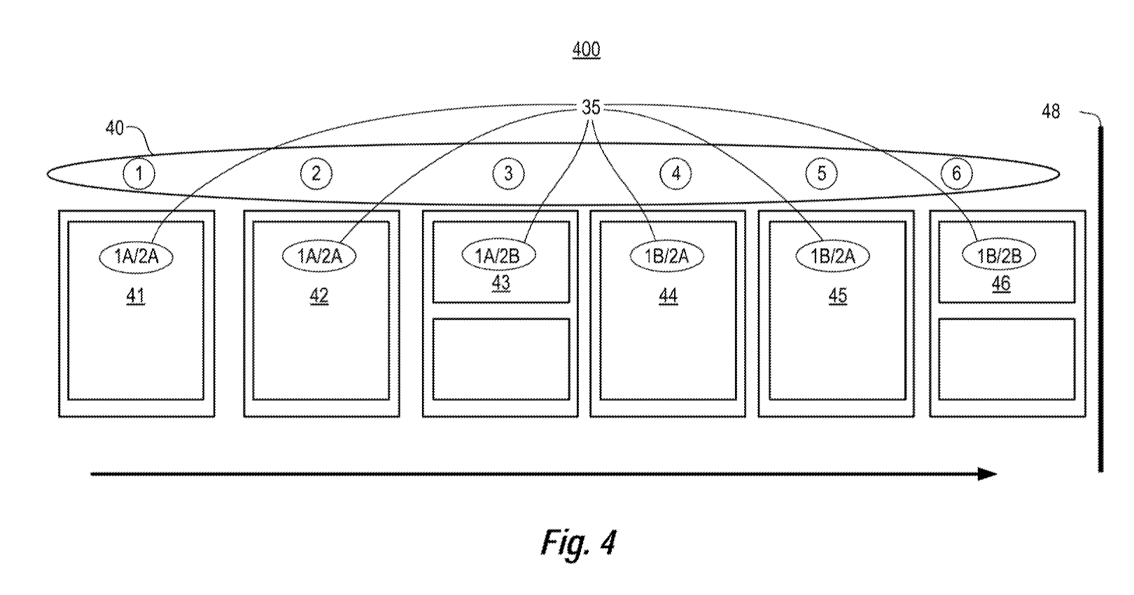

FIG. 4 illustrates a reset print queue 400 according to an example. The reset print queue 400 shows six pages that form multiple print jobs with the six pages ranked 40 based on the print characteristics 31 illustrated and the priority values 35 provided. Pages 41-46 referenced in FIG. 4 are prioritized based on page size and image coverage area. For example, the pages are first ordered by page size. Since pages 41, 42, and 43 are larger pages, such as A4 sized paper, (priority value 1A) compared to letter sized paper, pages 44, 45, and 46 (priority value 1B), pages 41, 42, and 43 are ordered in the print queue to print before pages 44, 45, and 46. Next, pages 41, 42, and 43 are ordered based on image coverage area, for example priority values 2A and 2B. As illustrated by the priority values 35, page 41 is ordered first with priority values 35 of 1A/2A, page 42 is ordered second with priority values 35 1A/2A, and page 43 is ordered third with priority values 35 1A/2B. Then, pages 44, 45, and 46 are ordered based on image coverage area with page 44 ordered fourth with priority values 35 1B/2A, page 45 ordered fifth with priority values 35 1B/2A, and page 46 ordered sixth with priority values 35 1B/2B.

The reset print queue 400 uses the priority values 35 based on the print characteristics 31 to order the pages of multiple print jobs. The reset print queue 400 may be ordered to mix lower priority values 35 with higher priority values 35 to reduce memory on the image transfer media 18. The reset print queue may be ordered such that the print jobs are completed simultaneously, in sequence, and/or continuously move between print jobs to keep a cyclic and uninterrupted flow in the printing. Moreover, the number of pages printed from each print job may be the same and/or dynamically vary depending on the print characteristics 31 and/or priority values 35 to avoid under utilizing and/or over utilizing a portion of the image transfer media 18 during a printing period. The reset print queue 400 further includes a break 48 that indicates when it is recommended to change the image transfer media 18, such as a blanket on a printing press.

For example, the reset print queue 400 may alternate printing between three print jobs, such that, page 41 is from print job 1 page 42 is from print job 2, and page 43 is from print job 1. The order may continue to alternate page by page depending on the print characteristic 31 and/or the method used to determine the order. The next three pages 44-46 are from print job 3. The print jobs are each directed to a separate output tray by a distribution mechanism 19 to keep each print job separate and ordered. Moreover, the reset print queue 400 may similarly be used, if each page is queued as a separate print job, i.e., pages 41-46. For example, the reset print queue 400 may print multiple pages, such as one-hundred copies of page 41, prior to printing multiple copies of page 42. In both examples, the reset print queue 400 reduces memory on the image transfer media 18.

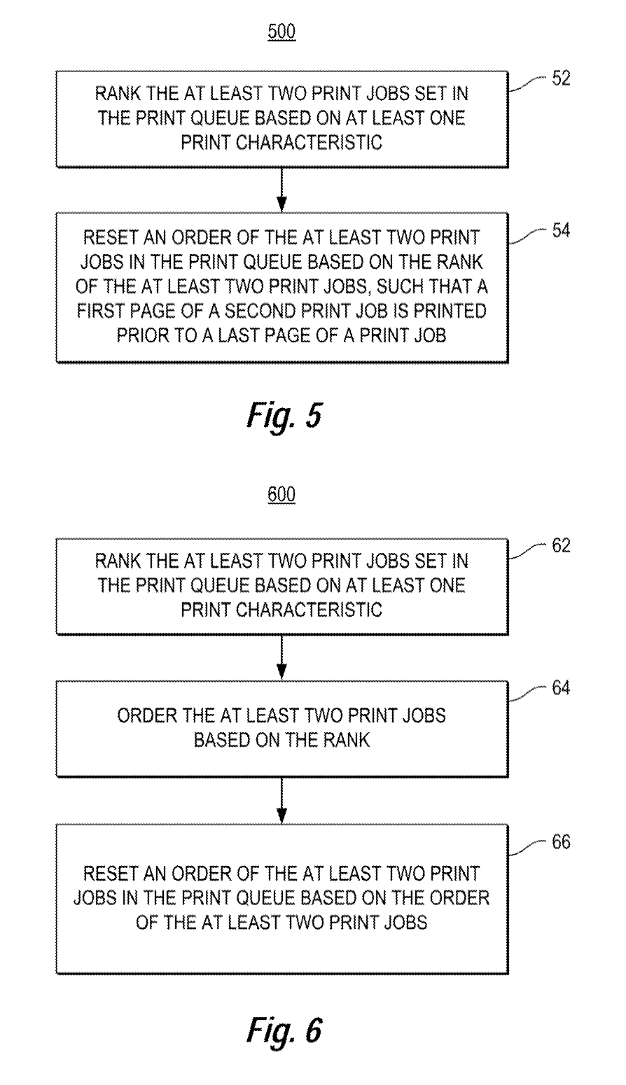

FIG. 5 illustrates a flow chart of a method 500 to order at least two print jobs in a print queue according to an example. The method 500 orders at least two print jobs in a print queue of an image forming system. In block 52, the method ranks the at least two print jobs set in the print queue based on at least one print characteristic. The rank may be determined by, for example, a comparison of the at least one print characteristic from each of the at least two print jobs.

The rank of the at least two print jobs may be based on, for example, a media size, a color hue, and/or an image coverage area. Using the example print characteristics, the rank may provide for the ordering of the print jobs. In a first example, a large media size is ordered before a small media size. In a second example, a dark hue is ordered before a light hue. In a third example, a full coverage area of an image transfer media is ordered before a partial coverage area of the image transfer media. Examples may be found in FIGS. 3-4 described above.

Moreover, the rank may be based on priority values, such that at least one print characteristic may be associated with a priority value. For example, at least three print characteristics may be used where the ranking assigns the following priority values based on the print characteristics. The media size is assigned a first priority value of at least one of greater than and equal to at least one of the image coverage area, the media type, the number of media sheets, the color hue, the repeated image pattern, and the image position. The image coverage area is assigned a second priority value of at least one of less than and equal to at least one of the repeated image pattern, the media type, the number of media sheets, the color hue, and the image position.

The method 500 then resets an order of the at least two print jobs in the print queue based on the ranking of the at least two print jobs in block 54. The order arranges the print jobs such that a first page of a second print job is ordered prior to a last page of a first print job. For example, the control unit may order the print queue by priority values in an order that alternates priority values between high priority values and low priority values to minimize memory on an image transfer media, such as a blanket.

FIG. 6 illustrates a flow chart of a method 600 to order at least two print jobs in a print queue according to a further example. In block 62, the at least two print jobs set in the print queue are ranked based on at least one print characteristic. The at least two print jobs are ordered based on the rank of the at least two print jobs in block 64. The method 600 ranks the at least two print jobs set in the print queue based on at least two print characteristics. The rank may include the assignment of a priority value to pages of the at least two print jobs based on a comparison of the at least one print characteristic of each of the at least two print jobs. The order of the at least two print jobs may be selectively controlled. For example, an order in which the at least two print jobs having at least two images are printed is controlled such that a first page of a second print job is ordered prior to a last page of a first print job. The order of the at least two print jobs may further be based on a comparison of the at least two print characteristics. The selective control of an order may include the order being determined based on at least one print characteristic and at least one other characteristic of the image forming system, such as a maintenance schedule of an image forming system.

In block 66, the order of the at least two print jobs are reset in the print queue based on the order of the at least two print jobs. Priority values may also be used to order the print queue. For example, the control unit may order the print queue by priority values in an order that alternates priority values between high priority values and low priority values to minimize memory on an image transfer media, such as a blanket. The method 600 may also assign an output tray to each one of the at least two print jobs.

The present disclosure has been described using non-limiting detailed descriptions of examples thereof and is not intended to limit the scope of the present disclosure. It should be understood that features and/or operations described with respect to one example may be used with other examples and that not all examples of the present disclosure have all of the features and/or operations illustrated in a particular figure or described with respect to one of the examples. Variations of examples described will occur to persons of the art. Furthermore, the terms “comprise,” “include,” “have” and their conjugates, shall mean, when used in the present disclosure and/or claims, “including but not necessarily limited to.”

It is noted that some of the above described examples may include structure, acts or details of structures and acts that may not be essential to the present disclosure and are intended to be exemplary. Structure and acts described herein are replaceable by equivalents, which perform the same function, even if the structure or acts are different, as known in the art. Therefore, the scope of the present disclosure is limited only by the elements and limitations as used in the claims.

What is claimed is:

1. An image forming system, comprising:
a control unit to selectively control an order in which at least two print jobs having at least two images are printed such that a first page of a second print job is ordered prior to a last page of a first print job;
an image forming unit to form each one of the at least two images such that the order that the at least two images are formed is controlled by the control unit;
an image transfer media to receive each one of the at least two images formed on the image forming unit and transfer each one of the at least two images to media to form at least two printed pages; and
a distribution mechanism to direct the at least two printed pages from the image forming unit to a plurality of output trays, such that each one of the at least two print jobs correspond to one of the plurality of output trays.

2. The image forming system of claim 1, further comprising a selection unit to select the order that the at least two print jobs are printed based on at least one print characteristic.

3. The image forming system of claim 2, wherein the selection unit further comprises a priority module and an order module, the priority module to assign a priority value to each page of the at least two print jobs based on the at least one print characteristic, and the order module to rank each of the at least two print jobs based on the priority value, such that one of the at least two print jobs is ranked prior to the other of the at least two print jobs.

4. The image forming system of claim 2, wherein the at least one print characteristic comprises at least one of a media type, a media size, a number of media sheets, an image coverage area, a color hue, a repeated image pattern, and an image position.

5. The image forming system of claim 1, further comprising the plurality of output trays to receive the at least two printed pages formed on the image transfer media.

6. A method to order at least two print jobs in a print queue of an image forming system, the method comprising:
ranking the at least two print jobs set in the print queue based on at least one print characteristic; and
resetting an order of the at least two print jobs in the print queue based on the ranking of the at least two print jobs, such that a first page of a second print job is ordered prior to a last page of a first print job.

7. The method of claim 6, wherein the at least one print characteristic comprises at least one of a media type, a media size, a number of media sheets, an image coverage area, a color hue, a repeated image pattern, and an image position.

8. The method of claim 7, wherein ranking the at least two print jobs further comprises ranking the at least two print jobs based on the media size, such that a large media size is ordered before a small media size.

9. The method of claim 7, wherein ranking the at least two print jobs further comprises ranking the at least two print jobs based on the color hue, such that a dark hue is ordered before a light hue.

10. The method of claim 7, wherein ranking the at least two print jobs further comprises ranking the at least two print jobs based on an image coverage area, such that a full coverage area of an image transfer media is ordered before a partial coverage area of the image transfer media.

11. The method of claim 7, wherein ranking the at least two print jobs further comprises ranking the at least two print jobs based on at least three print characteristics, such that the ranking assigns:
the media size a first priority value of at least one of greater than and equal to at least one of the image coverage area, the media type, the number of media sheets, the color hue, the repeated image pattern, and the image position; and
the image coverage area a second priority value of at least one of less than and equal to at least one of the repeated image pattern, the media type, the number of media sheets, the color hue, and the image position.

12. The method of claim 6, wherein ranking the at least two print jobs further comprises comparing the at least one print characteristic from each of the at least two print jobs to determine the ranking.

13. A method to order at least two print jobs in a print queue of an image forming system, the method comprising:
ranking the at least two print jobs set in the print queue based on at least one print characteristic;
ordering the at least two print jobs based on the ranking of the at least two print jobs; and
resetting an order of the at least two print jobs in the print queue based on the ordering of the at least two print jobs.

14. The method of claim 13, wherein the at least one print characteristic comprises at least one of a media type, a media size, a number of media sheets, an image coverage area, a color hue, a repeated image pattern, and an image position.

15. The method of claim 13, wherein ranking the at least two print jobs further comprises ranking the at least two print jobs set in the print queue based on at least two print characteristics.

16. The method of claim 15, wherein ordering the at least two print jobs further comprises ordering the at least two print jobs based on a comparison of the at least two print characteristics.

17. The method of claim 13, wherein ordering the at least two print jobs further comprises selectively controlling an order in which the at least two print jobs having at least two images are printed such that a first page of a second print job is ordered prior to a last page of a first print job.

18. The method of claim 17, wherein selectively controlling an order further comprises determining the order based on the at least one print characteristic and a maintenance schedule of an image forming system.

19. The method of claim 17, further comprising assigning an output tray to each one of the at least two print jobs.

20. The method of claim 13, wherein ranking the at least two print jobs further comprises assigning a priority value to the at least two print jobs based on a comparison of the at least one print characteristic of each of the at least two print jobs.
